(19) United States
(12) Patent Application Publication
(10) Pub. No.: US 2013/0088730 A1
(43) Pub. Date: Apr. 11, 2013

(54) IMAGE PROCESSING APPARATUS, IMAGE FORMING APPARATUS, IMAGE PROCESSING SYSTEM, IMAGE PROCESSING METHOD, AND NON-TRANSITORY COMPUTER READABLE MEDIUM

(71) Applicant: Koichi SATO, Kanagawa (JP)

(72) Inventor: Koichi SATO, Kanagawa (JP)

(73) Assignee: FUJI XEROX CO., LTD., Tokyo (JP)

(21) Appl. No.: 13/451,911

(22) Filed: Apr. 20, 2012

(30) Foreign Application Priority Data
Oct. 5, 2011 (JP) 2011-221202

(51) Int. Cl. H04N 1/60; G06K 15/02; H04N 1/40

(52) U.S. Cl. 358/1.9; 358/448

(57) ABSTRACT

An image processing apparatus includes a memory, a read image receiver, a color converter, and a display. The memory stores, regarding a multicolor color sample including sample images for plural predetermined colors, the colors of the sample images included in the multicolor color sample and information about sample images included in a single-color color sample in association with each other, the single-color color sample being generated by a specific image forming apparatus. The read image receiver receives a read image, the read image being an image obtained by reading a printed image generated by printing, using a single color, an image of plural colors by the specific image forming apparatus. The color converter converts the single color of the read image into plural colors on the basis of an association stored in the memory. The display displays an image of the plural colors generated through conversion.

### CROSS-REFERENCE TO RELATED APPLICATIONS

This application is based on and claims priority under 35 USC 119 from Japanese Patent Application No. 2011-221202 filed Oct. 5, 2011.

### BACKGROUND

### Technical Field

The present invention relates to an image processing apparatus, an image forming apparatus, an image processing system, an image processing method, and a non-transitory computer readable medium.

### SUMMARY

According to an aspect of the invention, there is provided an image processing apparatus including a memory, a read image receiver, a color converter, and a display. The memory stores, regarding a multicolor color sample including sample images for plural predetermined colors, the colors of the sample images included in the multicolor color sample and information about sample images included in a single-color color sample for the multicolor color sample in association with each other, the single-color color sample being generated by a specific image forming apparatus. The read image receiver receives a read image, the read image being an image obtained by reading a printed image which is generated by printing, using a single color, an image of plural colors by the specific image forming apparatus. The color converter converts the single color of the read image received by the read image receiver into plural colors on the basis of an association stored in the memory. The display displays an image of the plural colors generated through conversion performed by the color converter.

### BRIEF DESCRIPTION OF THE DRAWINGS

Exemplary embodiments of the present invention will be described in detail based on the following figures, wherein:

FIG. 1 is a schematic diagram illustrating an image processing system according to a first exemplary embodiment of the present invention;

FIG. 2 is a cross-sectional view of an image forming apparatus included in the image processing system according to the first exemplary embodiment of the present invention;

FIG. 3 is a schematic diagram illustrating a hardware configuration of the image forming apparatus included in the image processing system according to the first exemplary embodiment of the present invention;

FIG. 4 is a block diagram illustrating a functional configuration of an image processor included in the image forming apparatus according to the first exemplary embodiment of the present invention;

FIG. 5 is a schematic diagram illustrating a hardware configuration of an image processing apparatus included in the image processing system according to the first exemplary embodiment of the present invention;

FIG. 6 is a block diagram illustrating a functional configuration of the image processing apparatus realized when a control program according to the first exemplary embodiment of the present invention is executed;

FIG. 7 is a plan view illustrating an example of color-sample image data stored in a color-sample image data memory;

FIG. 8 is a schematic diagram illustrating a first example of dot arrays analyzed by an associating unit;

FIG. 9 is a schematic diagram illustrating a second example of dot arrays analyzed by the associating unit;

FIG. 10 is a flowchart illustrating a process of generating a table, which is data indicating association;

FIG. 11 is a flowchart illustrating a process of performing color conversion on an image of a single color and displaying the image;

FIG. 12 is a block diagram illustrating a functional configuration of an image processor included in the image forming apparatus according to a second exemplary embodiment of the present invention; and

FIG. 13 is a flowchart illustrating a process of performing color conversion on an image of a single color and printing the image.

### DETAILED DESCRIPTION

Hereinafter, a first exemplary embodiment of the present invention will be described in detail with reference to the drawings.

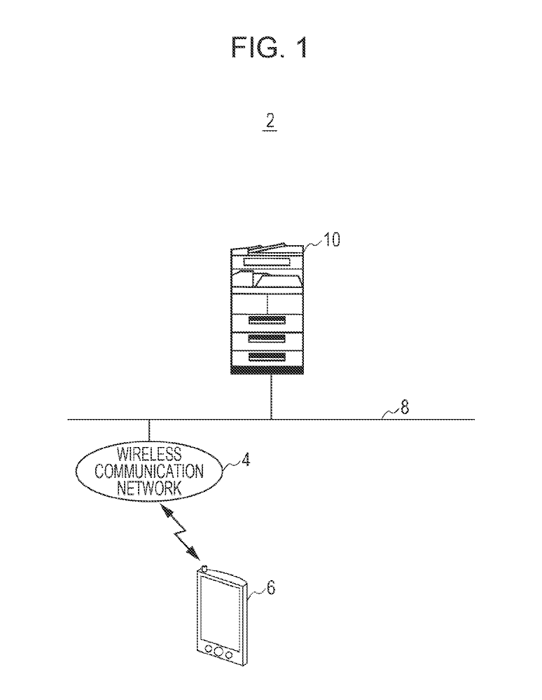

FIG. 1 is a schematic diagram illustrating an image processing system 2 according to the first exemplary embodiment of the present invention. As illustrated in FIG. 1, the image processing system 2 includes an image processing apparatus 6 connected to a wireless communication network 4 through wireless communication, and an image forming apparatus 10 connected to a network 8.

The wireless communication network 4 is connected to the network 8, so that the image processing apparatus 6 and the image forming apparatus 10 are capable of transmitting data to/receiving data from each other. The image processing apparatus 6 may be connected to the network 8 through wired communication or may be directly connected to the image forming apparatus 10 without through the network 8. First, the image forming apparatus 10 will be described.

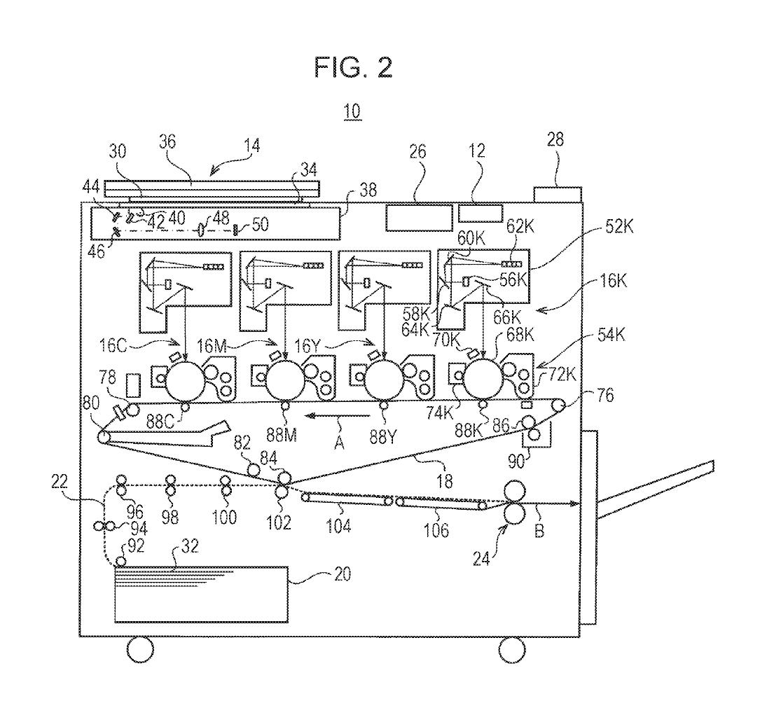

FIG. 2 is a cross-sectional view of the image forming apparatus 10 included in the image processing system 2 according to the first exemplary embodiment of the present invention.

As illustrated in FIG. 2, the image forming apparatus 10 includes a communication device 12, an image reading unit 14, an image forming unit 16, an intermediate transfer belt 18, a sheet tray 20, a sheet transport path 22, a fixing device 24, an image processor 26, and a user interface (UI) device 28.

The image forming apparatus 10 has a copying function of printing image data read by using the image reading unit 14, in addition to a printing function of printing image data received by the communication device 12 from the image processing apparatus 6 or the like via the network 8. Here, the image forming apparatus 10 is capable of performing printing with plural colors (color printing) and printing with a single color (monochrome printing) by using the printing function.

First, an overview of the image forming apparatus 10 will be described. The communication device 12, the image reading unit 14, and the image processor 26 are provided at an upper part of the image forming apparatus 10. The communication device 12 communicates with an external apparatus, such as the image processing apparatus 6, via the network 8. The image reading unit 14 reads an image on a document 30 and outputs the read image to the image processor 26. The image processor 26 performs a process described below on image data received from the image reading unit 14 or image data received from the image processing apparatus 6 or the like via the network 8, such as a local area network (LAN), and outputs the processed image data to the image forming unit 16.

The UI device 28, such as a touch panel, is provided on an upper surface of the image forming apparatus 10. The UI device 28 displays control information or instruction information about the image forming apparatus 10, and also receives an input of instruction information from a user. That is, the user is capable of operating the image forming apparatus 10 via the UI device 28. The UI device 28 may include a switch or the like for receiving input, or may include a display for outputting data, or may include a combination of the switch and display.

The image forming unit 16 is provided below the image reading unit 14. The image forming unit 16 includes plural image forming units corresponding to the colors constituting a color image. In this exemplary embodiment, a first image forming unit 16K, a second image forming unit 16Y, a third image forming unit 16M, and a fourth image forming unit 16C corresponding to black (K), yellow (Y), magenta (M), and cyan (C), respectively, are horizontally arranged at certain intervals along the intermediate transfer belt 18. The intermediate transfer belt 18 serves as an intermediate transfer body and rotates in the direction indicated by an arrow A illustrated in FIG. 2.

In the case of realizing a printing function with the use of plural colors, the four image forming units 16K, 16Y, 16M, and 16C sequentially form toner images of respective colors on the basis of image data received from the image processor 26, and first transfer the toner images onto the intermediate transfer belt 18 at the respective timings so that the toner images are superimposed on one another. The color order of the image forming units 16K, 16Y, 16M, and 16C is not limited to K, Y, M, and C, and another order may be used, for example, Y, M, C, and K. Hereinafter, printing with the use of plural colors will be referred to as “color printing”.

On the other hand, in the case of realizing a printing function with the use of a single color, the image forming unit 16K among the four image forming units 16K, 16Y, 16M, and 16C forms a black toner image on the basis of image data received from the image processor 26, and first transfers the toner image onto the intermediate transfer belt 18, thereby performing printing with the use of the single color. In the printing with the use of a single color, the color to be used is not limited to black, and another single color may be used. Hereinafter, printing with the use of a single color will be referred to as “monochrome printing”.

The sheet transport path 22 is provided below the intermediate transfer belt 18. A recording sheet 32 fed from the sheet tray 20 is transported along the sheet transport path 22, toner images of respective colors that have been transferred onto the intermediate transfer belt 18 are second transferred onto the recording sheet 32 in a collective manner, the transferred toner images are fixed onto the recording sheet 32 by the fixing device 24, and the recording sheet 32 is output to the outside along an arrow B. In the case of monochrome printing, only a black toner image that has been transferred onto the intermediate transfer belt 18 is second transferred onto the recording sheet 32.

Next, each element of the image forming apparatus 10 will be described more specifically.

As illustrated in FIG. 2, the image reading unit 14 includes a platen glass 34 on which the document 30 is to be placed, a platen cover 36 for pressing the document 30 onto the platen glass 34, and an image reader 38 for reading an image of the document 30 placed on the platen glass 34. The image reader 38 illuminates, using a light source 40, the document 30 placed on the platen glass 34, scans and exposes a light image reflected from the document 30 onto an image reading device 50, such as a charge-coupled device (CCD), through a reduction optical system that includes a full rate mirror 42, a first half rate mirror 44, a second half rate mirror 46, and an imaging lens 48, and reads, using the image reading device 50, the reflected color light image of the document 30 with a predetermined dot density.

The image processor 26 performs image processing, such as a color-space conversion process and a screen process described below, on image data read by the image reading unit 14 or image data input via the network 8. A reflected color light image of the document 30 read by the image reading unit 14 is, for example, document reflectance data of three colors including red (R), green (G), and blue (B), and is converted into color gradation data of four colors including Y, M, C, and K through image processing performed by the image processor 26. However, in the case of monochrome printing, the document reflectance data is converted into color gradation data of only black.

The first image forming unit 16K, the second image forming unit 16Y, the third image forming unit 16M, and the fourth image forming unit 16C are arranged in parallel along the horizontal direction at certain intervals, and have almost the same configuration except that the colors of images formed thereby are different from one another. Hereinafter, the first image forming unit 16K will be described. The elements of the individual image forming units 16 are distinguished from one another by attaching K, Y, M, or C to the respective reference numerals.

The first image forming unit 16K includes an optical scanning device 52K that scans a laser beam in accordance with image data received from the image processor 26, and an image forming device 54K that forms an electrostatic latent image using the laser beam scanned by the optical scanning device 52K.

The optical scanning device 52K modulates a semiconductor laser 56K in accordance with image data of black, and causes the semiconductor laser 56K to emit a laser beam LB (K) in accordance with the image data. The laser beam LB (K) emitted from the semiconductor laser 56K is applied to a rotary polygon mirror 62K via a first reflective mirror 58K and a second reflective mirror 60K, is deflected and scanned by the rotary polygon mirror 62K, and is applied onto a photoconductor drum 68K of the image forming device 54K via the second reflective mirror 60K, a third reflective mirror 64K, and a fourth reflective mirror 66K.

The image forming device 54K includes the photoconductor drum 68K, serving as an image carrier which rotates at a certain rotation speed along the direction indicated by the arrow A, a scorotron 70K for first charging, serving as a charging unit for causing the surface of the photoconductor drum 68K to be evenly charged, a developing device 72K for developing an electrostatic latent image formed on the photoconductor drum 68K, and a cleaning device 74K. The photoconductor drum 68K is evenly charged by the scorotron 70K, and an electrostatic latent image is formed thereon due to the laser beam LB (K) applied from the optical scanning device 52K. The electrostatic latent image formed on the photoconductor drum 68K is developed by the developing device 72K using a black toner, and is transferred onto the intermediate transfer belt 18. A residual toner and paper dust or the like that remain on the photoconductor drum 68K after transfer of the toner image are removed by the cleaning device 74K.

The other image forming units 16Y, 16M, and 16C form toner images of Y, M, and C, respectively, in a manner similar to that described above, and transfer the respective toner images onto the intermediate transfer belt 18.

The intermediate transfer belt 18 extends around a drive roller 76, a first idle roller 78, a steering roller 80, a second idle roller 82, a backup roller 84, and a third idle roller 86 at a certain tension, and is driven to rotate at a certain speed in the direction indicated by the arrow A when the drive roller 76 is driven to rotate by a driving motor (not illustrated). The intermediate transfer belt 18 is an endless belt formed by, for example, forming a band made of a synthetic-resin film having elasticity, such as a polyimide film, and connecting both ends of the band using welding or the like.

Also, a first first-transfer roller 88K, a second first-transfer roller 88Y, a third first-transfer roller 88M, and a fourth first-transfer roller 88C are provided along the intermediate transfer belt 18, at the positions facing the respective image forming units 16K, 16Y, 16M, and 16C. Toner images of the respective colors that have been formed on the photoconductor drums 68K, 68Y, 68M, and 68C are transferred onto the intermediate transfer belt 18 by the first-transfer rollers 88 so as to be superimposed on one another. A residual toner on the intermediate transfer belt 18 is removed by a cleaning blade or brush of a belt cleaner 90 provided downstream of a second-transfer position.

A feed roller 92 for taking the recording sheet 32 from the sheet tray 20; a first pair of rollers 94, a second pair of rollers 96, and a third pair of rollers 98 for transporting the recording sheet 32; and resist rollers 100 for transporting the recording sheet 32 to the second-transfer position at a predetermined timing, are provided along the sheet transport path 22.

Also, a second-transfer roller 102 that is in contact with the backup roller 84 is provided at the second-transfer position along the sheet transport path 22. Toner images of the respective colors transferred onto the intermediate transfer belt 18 are second-transferred onto the recording sheet 32 due to the contact pressure and static electricity generated by the second-transfer roller 102. The recording sheet 32 onto which the toner images of the respective colors have been transferred is transported to the fixing device 24 by a first transport belt 104 and a second transport belt 106.

The fixing device 24 performs heating and pressurization on the recording sheet 32 onto which the toner images of the respective colors have been transferred, thereby causing the toner to be melted and fixed to the recording sheet 32.

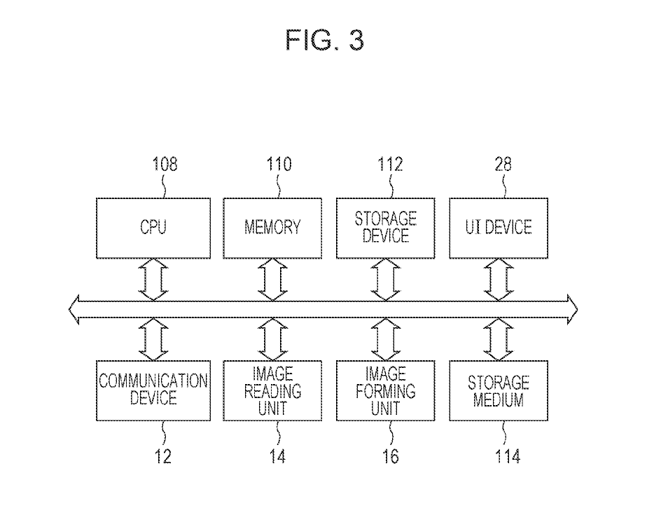

FIG. 3 is a schematic diagram illustrating a hardware configuration of the image forming apparatus 10 included in the image processing system 2 according to the first exemplary embodiment of the present invention.

As illustrated in FIG. 3, the image forming apparatus 10 includes a central processing unit (CPU) 108, a memory 110, a storage device 112, the UI device 28, the communication device 12, the image reading unit 14, and the image forming unit 16. The image forming apparatus 10 has a configuration serving as a computer capable of communicating with the image processing apparatus 6 and the network 8.

The CPU 108 executes a process based on a program stored in the memory 110. The storage device 112 may be, for example, a built-in hard disk drive (HDD). The CPU 108 may execute a program stored in the storage device 112.

The CPU 108 may execute a program stored in a storage medium 114, such as a memory card, and may execute a program supplied via the communication device 12.

As described above, the UI device 28 is, for example, a touch panel, and functions as a display for displaying information and as an input receiving device for receiving input performed by a user.

The communication device 12 communicates with an external apparatus, such as the image processing apparatus 6, via the network 8 (wireless communication network 4). The image reading unit 14 and the image forming unit 16 have been described above.

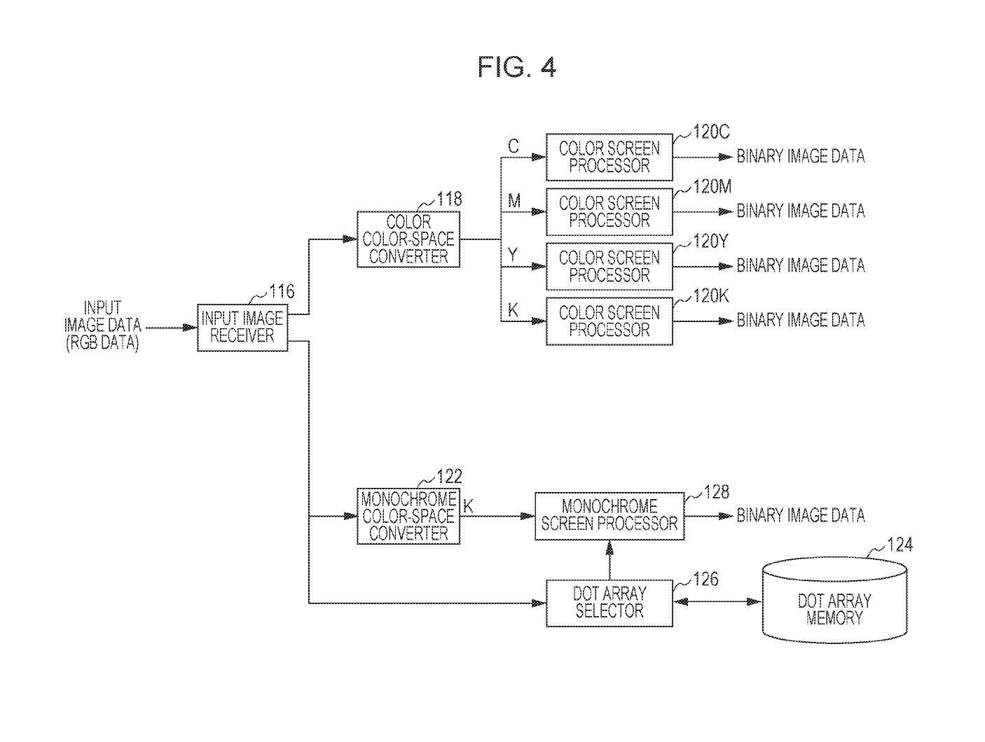

FIG. 4 is a block diagram illustrating a functional configuration of the image processor 26.

As illustrated in FIG. 4, the image processor 26 includes an input image receiver 116, a color color-space converter 118, color screen processors 120C, 120M, 120Y, and 120K, a monochrome color-space converter 122, a dot array memory 124, a dot array selector 126, and a monochrome screen processor 128.

The individual elements included in the image processor 26 may be realized in a software manner by the CPU 108, the memory 110, and a program, or may be realized in a hardware manner by an application specific integrated circuit (ASIC) or the like.

In the image processor 26, the input image receiver 116 receives input image data expressed by, for example, an RGB color space, from the image reading unit 14 or the image processing apparatus 6. The input image receiver 116 outputs the received input image data to the color color-space converter 118 in the case of performing color printing, and outputs the received input image data to the monochrome color-space converter 122 and the dot array selector 126 in the case of performing monochrome printing.

First, the case of performing color printing will be described.

The color color-space converter 118 converts the input image data received from the input image receiver 116 into pieces of multilevel image data corresponding to C, M, Y, and K, and outputs the pieces of multilevel image data to the color screen processors 120C, 120M, 120Y, and 120K, respectively.

The color screen processors 120C, 120M, 120Y, and 120K perform a screen process (dot process) on the pieces of multilevel image data received from the color color-space converter 118, thereby converting the pieces of multilevel image data, which has density gradation, into pieces of binary image data. The pieces of binary image data generated through the screen process performed by the color screen processors 120C, 120M, 120Y, and 120K are output to the image forming unit 16.

Next, the case of performing monochrome printing will be described. In the image forming apparatus 10 according to the first exemplary embodiment, in the case of printing a color image using a single color, binary image data is generated in accordance with dot arrays selected on the basis of colors of the color image. Here, a dot array is an array of dots (dot pattern) specified by the shape, screen angle, and resolution of dots.

The monochrome color-space converter 122 converts the input image data received from the input image receiver 116 into black data, and outputs the black data to the monochrome screen processor 128.

The dot array memory 124 stores dot arrays corresponding to plural predetermined colors. The dot arrays are used to perform a screen process on image data of the respective colors. The dot arrays corresponding to the plural predetermined colors are referred to as a “first dot array”. Also the dot array memory 124 stores a dot array used to perform a screen process on image data of a color other than the foregoing plural predetermined colors. This dot array is referred to as a “second dot array”. Here, the individual dot arrays included in the first dot array and the second dot array are different from one another.

The dot array selector 126 reads out, on the basis of colors included in the input image data received from the input image receiver 116, dot arrays used to perform a screen process from the dot array memory 124, and outputs the dot arrays to the monochrome screen processor 128.

The dot array selector 126 reads out, for any of the foregoing predetermined colors in the input image data, the dot array corresponding to the color in the first dot array from the dot array memory 124, and outputs the dot array to the monochrome screen processor 128. Also, the dot array selector 126 reads out, for a color other than the predetermined colors in the input image data, the second dot array from the dot array memory 124, and outputs the second dot array to the monochrome screen processor 128.

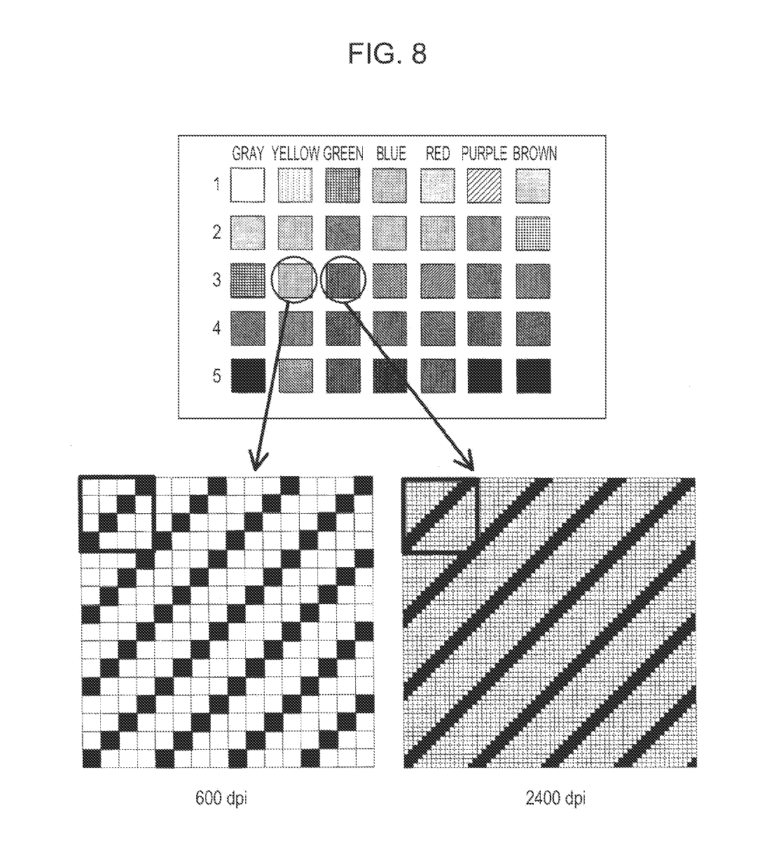

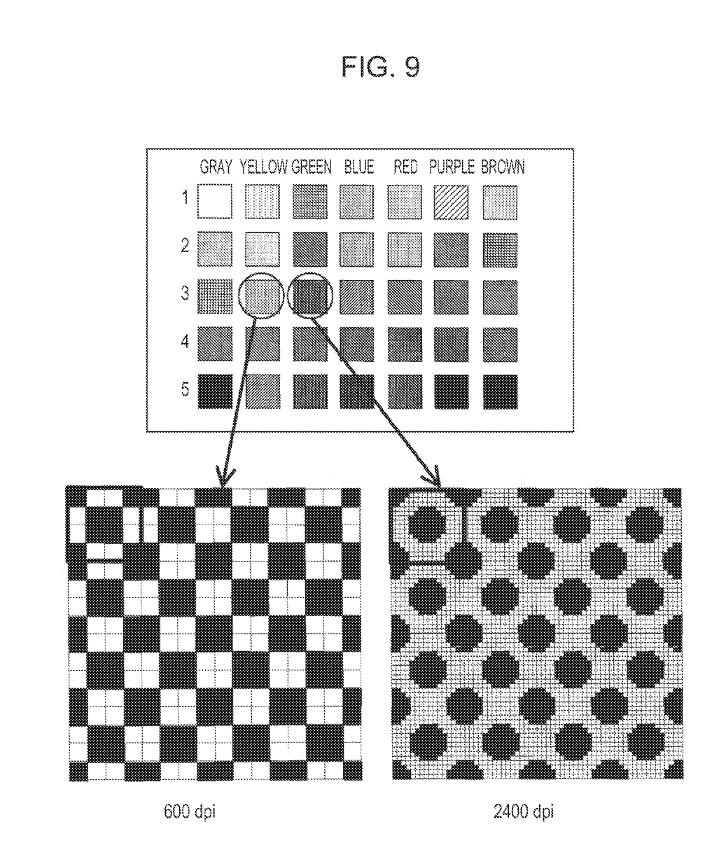

The monochrome screen processor 128 performs a screen process on the black multilevel image data received from the monochrome color-space converter 122 on the basis of the dot arrays selected by the dot array selector 126, thereby converting the multilevel image data into binary image data. The binary image data generated through the screen process performed by the monochrome screen processor 128 is output to the image forming unit 16. The dots formed through the process performed by the monochrome screen processor 128 will be described below with reference to FIGS. 8 and 9.

Next, the image processing apparatus 6 will be described.

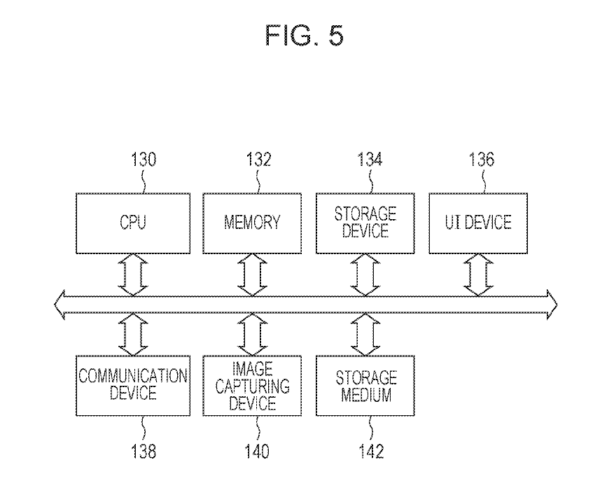

FIG. 5 is a schematic diagram illustrating a hardware configuration of the image processing apparatus 6 included in the image processing system 2 according to the first exemplary embodiment of the present invention.

As illustrated in FIG. 5, the image processing apparatus 6 includes a CPU 130, a memory 132, a storage device 134, a UI device 136, a communication device 138, and an image capturing device 140. The image processing apparatus 6 has a configuration serving as a computer capable of communicating with the image forming apparatus 10 via the network 8 (wireless communication network 4). In this exemplary embodiment, the image processing apparatus 6 may be a mobile terminal carried by a user, such as a mobile phone, a smart phone, or a mobile information terminal (personal digital assistance (PDA)).

The CPU 130 executes a process based on a control program (described below) stored in, for example, the memory 132. The storage device 134 is a built-in HDD, for example, and stores a table (described below). The CPU 130 may execute a control program stored in the storage device 134.

The CPU 130 may execute a control program stored in a storage medium 142, such as a memory card, or may execute a control program supplied via the communication device 138.

The UI device 136 is, for example, a touch panel, and functions as a display for displaying information and as an input receiving device for receiving input performed by a user.

The communication device 138 communicates with an external apparatus, such as the image forming apparatus 10, via the network 8 (wireless communication network 4).

The image capturing device 140 is a camera, which captures an image of a subject to obtain image data.

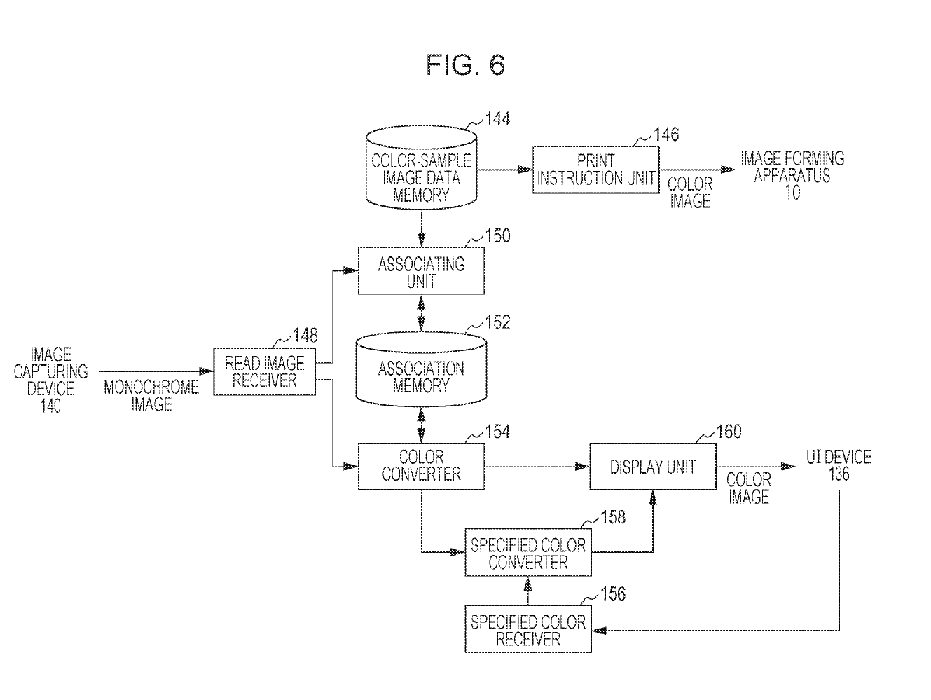

FIG. 6 is a block diagram illustrating a functional configuration of the image processing apparatus 6, the functional configuration being realized when a control program is executed. As illustrated in FIG. 6, the image processing apparatus 6 includes a color-sample image data memory 144, a print instruction unit 146, a read image receiver 148, an associating unit 150, an association memory 152, a color converter 154, a specified color receiver 156, a specified color converter 158, and a display unit 160.

The color-sample image data memory 144 stores color-sample image data, which is image data constituted by plural sample images of different densities for plural predetermined colors.

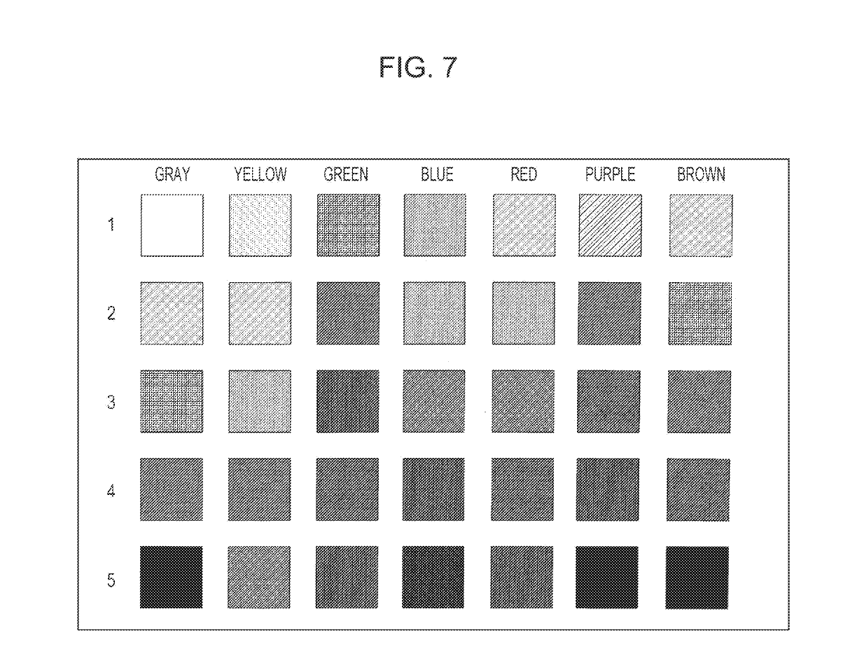

FIG. 7 is a plan view illustrating an example of color-sample image data stored in the color-sample image data memory 144. FIG. 7 illustrates color-sample image data including sample images of seven colors of gray, yellow, green, blue, red, purple, and brown, each having five levels of density.

In the description given below, the color-sample image data stored in the color-sample image data memory 144 may be referred to as a “color color-sample image”. Also, the sample images constituting the color-sample image data stored in the color-sample image data memory 144 (35 types of images in the example illustrated in FIG. 7) may be referred to as “color component images”.

The print instruction unit 146 instructs the image forming apparatus 10 to print, using a single color, the color-sample image data stored in the color-sample image data memory 144, and outputs the color-sample image data to the image forming apparatus 10.

The read image receiver 148 receives read image data, which is obtained by capturing and reading, by the image capturing device 140, an image printed using a single color. Also, the read image receiver 148 outputs the received read image data to the associating unit 150 or the color converter 154. Here, the read image receiver 148 outputs, to the associating unit 150, read image data obtained by capturing and reading an image printed using a single color by the image forming apparatus 10 in response to an instruction provided by the print instruction unit 146. The read image receiver 148 outputs the other read image data to the color converter 154. The read image receiver 148 may receive, as image data printed using a single color, image data received via the communication device 138, instead of the image data captured by the image capturing device 140.

In the description given below, read image data of an image obtained by printing a color color-sample image using a single color by the image forming apparatus 10 in response to an instruction provided by the print instruction unit 146 may be referred to as a “monochrome color-sample image”. Also, a single-color image corresponding to a color component image included in monochrome color-sample images may be referred to as a “monochrome component image”.

The associating unit 150 associates the color of each sample image included in a multicolor color sample with the color of a sample image included in a single-color color sample generated by a specific image forming apparatus. In the first exemplary embodiment, the associating unit 150 performs association on the basis of a feature of the specific image forming apparatus in printing using a single color. However, the associating unit 150 does not necessarily perform association for a color sample printed using a single color. For example, the associating unit 150 may perform association for a single-color color sample generated by the image forming apparatus, such as data obtained by converting a multicolor color sample into a single-color color sample by the image forming apparatus.

In the first exemplary embodiment, association is performed on the basis of a brightness and a dot array. The associating unit 150 may perform association on the basis of any one of a brightness and a dot array. Alternatively, the associating unit 150 may perform association on the basis of a feature unique to a specific image forming apparatus, the feature appearing in each color when the specific image forming apparatus performs printing using a single color, instead of a brightness or a dot array. In this case, in the case of printing a color image using a single color, the image forming apparatus 10 may not select a dot array on the basis of the color of the color image.

In the first exemplary embodiment, association is performed by generating data, which indicates the association of a brightness and a dot array with respect to color information, for each monochrome component image included in the monochrome color-sample image output from the read image receiver 148. Specifically, the associating unit 150 analyzes the brightness and dot array of a monochrome component image, and generates a table in which color information about a color component image corresponding to the monochrome component image is associated with the analyzed brightness and dot array. Also, the associating unit 150 stores the generated table in the association memory 152.

FIG. 8 is a schematic diagram illustrating a first example of dot arrays analyzed by the associating unit 150. As described above, in the case of printing a color image using a single color, the image forming apparatus 10 performs a screen process using a dot array selected on the basis of the color of the color image. Here, it is assumed that the dot array memory 124 of the image forming apparatus 10 at least stores the above-described first dot array for individual colors of color component images. Accordingly, in monochrome component images, dots are formed by different dot arrays for the individual colors of the color component images (in the example illustrated in FIG. 7, gray, yellow, green, blue, red, purple, and brown).

FIG. 8 illustrates a dot array of a monochrome component image corresponding to an yellow color component image and a dot array of a monochrome component image corresponding to a green color component image. Both the dot arrays have a linear pattern, but the resolutions thereof are different from each other.

FIG. 9 is a schematic diagram illustrating a second example of dot arrays analyzed by the associating unit 150. FIG. 8 illustrates a case where dot arrays having a linear pattern and different resolutions are formed by the image forming apparatus 10. In contrast, FIG. 9 illustrates a case where dot arrays having a dot pattern and different resolutions are formed by the image forming apparatus 10.

The exemplary embodiment is not limited to the examples illustrated in FIG. 8 or FIG. 9. For example, dot arrays having the same resolution and different patterns may be formed for different colors by the image forming apparatus 10. Alternatively, dot arrays having different resolutions and different patterns may be formed for different colors, or dot arrays having different screen angles may be formed for different colors.

Referring to the example illustrated in FIG. 8 or FIG. 9, in the monochrome component image for yellow, dot arrays in image regions each including 4×4 pixels are periodically arranged, and in the monochrome component image for green, dot arrays in image regions each including 16×16 pixels are periodically arranged. The associating unit 150 stores, in the association memory 152, a table indicating the association between image data of monochrome component images having dot arrays and color information. At this time, the size of the image data of a stored monochrome component image may be dependent on a period. For example, in the example illustrated in FIG. 8 or FIG. 9, the period of dots for yellow is smaller than the period of dots for green. Thus, image data of a monochrome component image having a size smaller than the image data stored for green (for example, 16×16 pixels) may be stored (for example, 4×4 pixels).

The color converter 154 converts a single-color image into a multicolor image on the basis of the association defined by the associating unit 150. In the first exemplary embodiment, the color converter 154 converts single-color image data output from the read image receiver 148 into multicolor image data on the basis of the table stored in the association memory 152. Specifically, the color converter 154 sequentially cuts out image segments from the single-color image data, analyzes the brightness and dot array of each image segment, and searches the table for the analyzed brightness and dot array. Then, the color converter 154 converts the color of the image segment on the basis of color information corresponding to the brightness and dot array found in the table. Also, the color converter 154 outputs the color-converted image segment to the display unit 160.

The size of each image segment that is to be cut out may be, for example, the size of the largest image data among pieces of image data of monochrome component images stored in the table in the association memory 152. Specifically, the size of each image segment that is to be cut out may be, for example, 16×16 pixels.

In the first exemplary embodiment, if the brightness and dot array of an image segment are not found in the table, the color converter 154 outputs the image segment to the specified color converter 158.

If color conversion is not performed on the basis of the table, the specified color receiver 156 receives, via the UI device 136, a specified color to be used for conversion from a user, and outputs the specified color to the specified color converter 158.

The specified color converter 158 performs color conversion on the image segment output from the color converter 154 by using the color received by the specified color receiver 156, and outputs the color-converted image segment to the display unit 160.

The display unit 160 combines individual image segments that have been color-converted by the color converter 154 or the specified color converter 158, and displays the combined image on the UI device 136.

In the description given above, color conversion is performed by using the specified color receiver 156 and the specified color converter 158 if color conversion is not performed on the basis of the table. However, the specified color receiver 156 and the specified color converter 158 may not be provided. Alternatively, an estimated color converter described below may be provided instead of the specified color receiver 156 and the specified color converter 158, or together with the specified color receiver 156 and the specified color converter 158.

The estimated color converter performs color conversion on an image segment that is not color-converted on the basis of the table, by using an estimated color. The color is estimated on the basis of the color of an image segment that has been color-converted on the basis of the table among adjacent image segments. For example, the estimated color converter performs color conversion using the same color as the color of the image segment that has been color-converted on the basis of the table.

Next, description will be given of a process of generating a table, which is data indicating association.

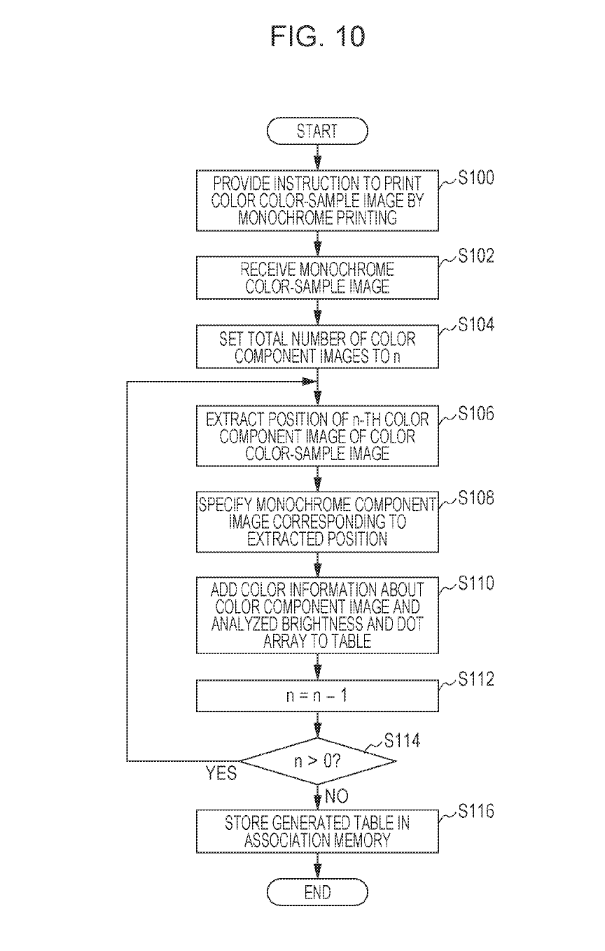

FIG. 10 is a flowchart illustrating the process of generating the table.

In step S100, the print instruction unit 146 instructs the image forming apparatus 10 to print, using a single color, a color color-sample image stored in the color-sample image data memory 144, and the process proceeds to step S102.

In step S102, the read image receiver 148 receives a monochrome color-sample image, which is data obtained by capturing a printed material obtained by printing color-sample image data by the image forming apparatus 10. The read image receiver 148 outputs the received data to the associating unit 150, and the process proceeds to step S104.

In step S104, the associating unit 150 sets the total number of color component images stored in the color-sample image data memory 144 to a variable n, and the process proceeds to step S106.

In step S106, the associating unit 150 extracts information about the position of the n-th color component image in the color color-sample image, and the process proceeds to step S108.

In step S108, the associating unit 150 specifies the monochrome component image at the position corresponding to the position extracted in step S106 from the monochrome color-sample image, and the process proceeds to step S110.

In step S110, the associating unit 150 analyzes the brightness and dot array of the monochrome component image specified in step S108, adds the color information about the color component image and the analyzed brightness and dot array to the table in association with each other, and the process proceeds to step S112.

In step S112, the associating unit 150 decrements the variable n by one, and the process proceeds to step S114.

In step S114, the associating unit 150 determines whether or not the variable n is larger than zero. If the variable n is larger than zero, the process returns to step S106. If the variable n is equal to or smaller than zero, the process proceeds to step S116.

In step S116, the associating unit 150 stores the generated table in the association memory 152.

Next, description will be given of a process of displaying an image that is obtained by color-converting an image that is obtained by printing, using a single color, a color image by the image forming apparatus 10.

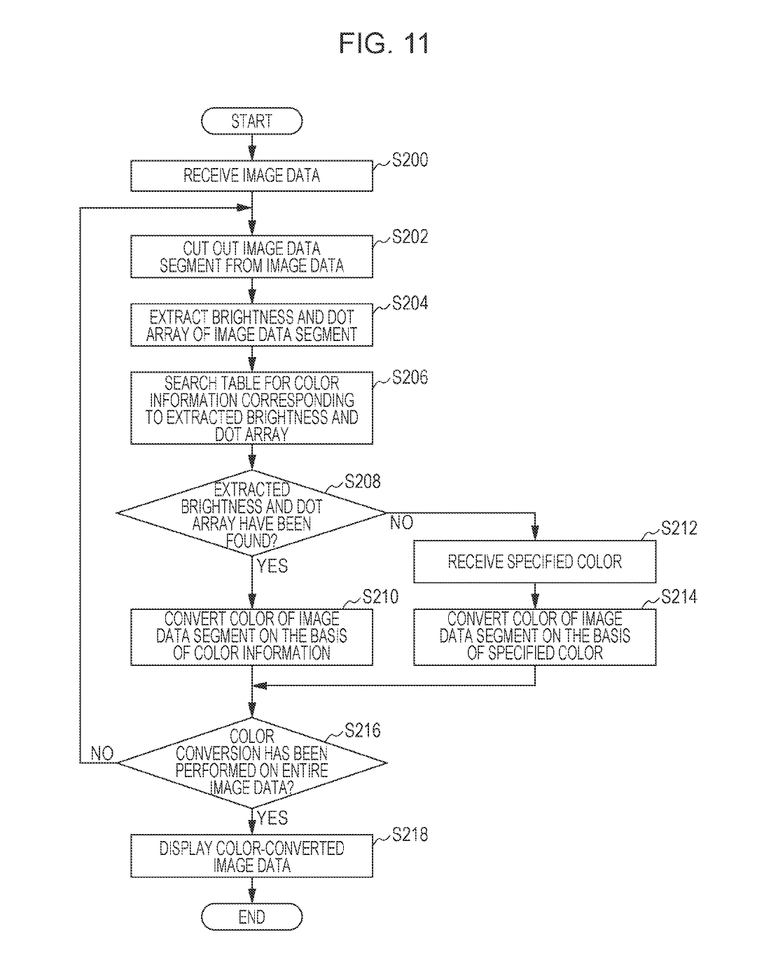

FIG. 11 is a flowchart illustrating the process of color-converting a single-color image and displaying the image.

In step S200, the read image receiver 148 receives image data obtained by capturing a printed material. The printed material that is to be captured is generated by printing, using a single color, color image data by the image forming apparatus 10. The read image receiver 148 outputs the received image data to the color converter 154, and the process proceeds to step S202.

In step S202, the color converter 154 cuts out an image data segment from the image data output from the read image receiver 148 in step S200, and the process proceeds to step S204.

In step S204, the color converter 154 analyzes the image data segment cut out in step S202, and extracts the brightness and dot array of the image data segment. Then the process proceeds to step S206.

In step S206, the color converter 154 searches the table for the color information corresponding to the brightness and dot array extracted in step S204, and the process proceeds to step S208.

In step S208, the color converter 154 determines whether or not the extracted brightness and dot array have been found in the table. If found, the process proceeds to step S210, and otherwise the process proceeds to step S212.

In step S210, the color converter 154 converts the color of the image data segment on the basis of the color information corresponding to the found brightness and dot array, and the process proceeds to step S216.

In step S212, the specified color receiver 156 receives a specified color from a user, and the process proceeds to step S214.

In step S214, the specified color converter 158 converts the color of the image data segment in accordance with the color received by the specified color receiver 156 in step S212, and the process proceeds to step S216.

In step S216, the color converter 154 determines whether or not color conversion has been performed on the entire image data output from the read image receiver 148 in step S200. If color conversion has been performed on the entire image data, the process proceeds to step S218. If color conversion has not been performed on the entire image data, the process returns to step S202 to perform color conversion on a next image data segment.

In step S218, the display unit 160 displays the color-converted image data.

In the above-described first exemplary embodiment, the association memory 152 stores a table generated by the associating unit 150. Alternatively, the association memory 152 may receive a table generated by another image processing apparatus and store the table. In this case, the color-sample image data memory 144, the print instruction unit 146, and the associating unit 150 are not necessary for displaying, using plural colors, image data of a single-color printed material.

Next, a second exemplary embodiment of the present invention will be described. The second exemplary embodiment is different from the first exemplary embodiment in that the image processor 26 in the image forming apparatus 10 is replaced with an image processor 162.

In the first exemplary embodiment, the image processing apparatus 6 performs color conversion on an image printed by using a single color by the image forming apparatus 10, and the image is displayed.

In the second exemplary embodiment, the image forming apparatus 10 performs the following process on a printed image obtained by printing a multicolor image using a single color, by using dot arrays associated in units of colors. That is, the printed image is read by the image reading unit 14, color conversion is performed on the basis of the dot arrays used in printing, and printing using plural colors (color printing) is performed.

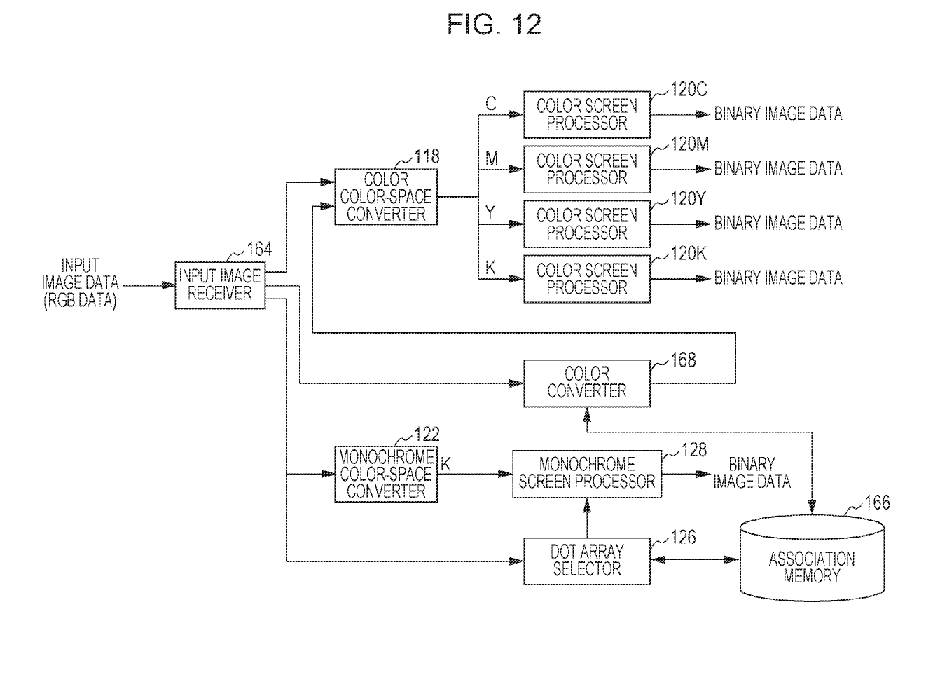

FIG. 12 is a block diagram illustrating a functional configuration of the image processor 162 included in the image forming apparatus 10 according to the second exemplary embodiment.

Hereinafter, a configuration different from that of the image processor 26 according to the first exemplary embodiment will be described.

As illustrated in FIG. 12, the image processor 162 is different from the image processor 26 in that the input image receiver 116 is replaced with an input image receiver 164, the dot array memory 124 is replaced with an association memory 166, and a color converter 168 is added.

Like the dot array memory 124 according to the first exemplary embodiment, the association memory 166 stores, in units of colors, dot arrays used for a screen process in the case of performing printing using a single color. Also, like the association memory 152 of the image processing apparatus 6 according to the first exemplary embodiment, the association memory 166 stores a table, which is data indicating the association of brightness and dot arrays with respect to color information for each of plural predetermined colors.

A dot array stored in the table and a dot array used for a screen process are the same in each color.

The input image receiver 164 has the function of the input image receiver 116 according to the first exemplary embodiment, and also outputs, to the color converter 168, input image data obtained by reading, by the image reading unit 14, a single-color printed material generated by the image forming apparatus 10.

When receiving input image data of a single-color image printed by the image forming apparatus 10 from the image processing apparatus 6 or the like, the input image receiver 164 may output the input image data to the color converter 168.

Like the color converter 154 of the image processing apparatus 6 according to the first exemplary embodiment, the color converter 168 converts the single-color image data output from the input image receiver 164 into multicolor image data on the basis of the table stored in the association memory 166. Also, the color converter 168 outputs the color-converted image data to the color color-space converter 118.

The configuration of the image processor 162 according to the second exemplary embodiment has been described. For example, like the image processing apparatus 6 according to the first exemplary embodiment, the image processor 162 may further include the specified color receiver 156 and the specified color converter 158. Alternatively, the image processor 162 may further include the above-described estimated color converter instead of the specified color receiver 156 and the specified color converter 158, or together with the specified color receiver 156 and the specified color converter 158.

Next, description will be given of a process of printing an image on which color conversion has been performed by the image forming apparatus 10.

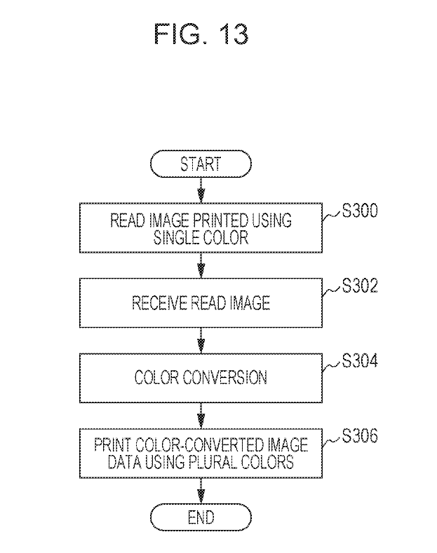

FIG. 13 is a flowchart illustrating the process of performing color conversion on a single-color image and printing the image.

In step S300, the image reading unit 14 reads an image printed using a single color, and the process proceeds to step S302. Here, the image to be read is obtained by printing color image data by using a single color by the image forming apparatus 10.

In step S302, the input image receiver 164 receives image data read in step S300, and outputs the image data to the color converter 168. Then, the process proceeds to step S304.

In step S304, the color converter 168 converts the single-color image data into multicolor image data on the basis of the table stored in the association memory 166, and outputs the image data to the color color-space converter 118. Here, the flow of specific operations in the conversion process is the same as steps S202 to S216 illustrated in FIG. 11.

In step S306, the image data on which color conversion is performed in step S304 is printed using plural colors. Specifically, color space conversion is performed by the color color-space converter 118, a screen process is performed by the color screen processors 120C, 120M, 120Y, and 120K, and printing is performed by the image forming unit 16.

In the second exemplary embodiment, a multicolor image is printed using a single color in accordance with dot arrays associated in units of colors, and color conversion is performed on the basis of the dot arrays. The color conversion may be performed on the basis of a feature unique to a specific image forming apparatus, the feature appearing in each color when the specific image forming apparatus performs printing using a single color, instead of on the basis of dot arrays.

In the case of performing color conversion on the basis of a feature unique to a specific image forming apparatus, the image forming apparatus does not need to use dot arrays associated in units of colors, when performing single-color printing. Alternatively, the color-sample image data memory 144, the print instruction unit 146, and the associating unit 150 provided in the image processing apparatus 6 according to the first exemplary embodiment may be further provided in the image forming apparatus 10, and the association memory 166 may store the association between colors and a unique feature that appears when the image forming apparatus 10 performs printing using a single color.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a memory that stores, regarding a multicolor color sample including sample images for a plurality of predetermined colors, the colors of the sample images included in the multicolor color sample and information about sample images included in a single-color color sample for the multicolor color sample in association with each other, the single-color color sample being generated by a specific image forming apparatus;
a read image receiver that receives a read image, the read image being an image obtained by reading a printed image which is generated by printing, using a single color, an image of a plurality of colors by the specific image forming apparatus;
a color converter that converts the single color of the read image received by the read image receiver into a plurality of colors on the basis of an association stored in the memory; and
a display that displays an image of the plurality of colors generated through conversion performed by the color converter.

2. The image processing apparatus according to claim 1,
wherein the memory stores at least any one of a brightness and a dot array of the sample images included in the single-color color sample and the colors of the sample images included in the multicolor color sample in association with each other, and
wherein the color converter converts the single color of the read image into the plurality of colors on the basis of one of a brightness and a dot array of the read image received by the read image receiver, the one of the brightness and the dot array being used in association in the memory.

3. The image processing apparatus according to claim 2,
wherein the memory stores, regarding a dot array that is periodically repeated, information about sample images of a single color having a size based on a period and the colors of the sample images included in the multicolor color sample in association with each other.

4. The image processing apparatus according to claim 1, further comprising:
a specified color receiver that receives a specified color; and
a specified color converter that converts a single color to be converted of an image segment into the specified color received by the specified color receiver.

5. The image processing apparatus according to claim 1, further comprising:
an estimated color converter that converts a single color to be converted of an image segment into a color estimated by referring to color conversion performed by the color converter on an image segment of a single color adjacent to the image segment of the single color to be converted.

6. An image forming apparatus comprising:
a single-color printing unit that prints, using a single color, an image of a plurality of colors in accordance with dot arrays associated in units of colors;
a reading unit that reads an image of the single color printed by the single-color printing unit;
a color converter that converts, on the basis of at least a dot array included in the image read by the reading unit, the single color of the image into a plurality of colors associated with the dot array; and
a multicolor printing unit that prints, using a plurality of colors, an image of the plurality of colors generated through conversion performed by the color converter.

7. An image processing system comprising:
an image forming apparatus including
a single-color printing unit that prints, using a single color, an image of a plurality of colors; and
an image processing apparatus including
a memory that stores, regarding a multicolor color sample including sample images for a plurality of predetermined colors, the colors of the sample images included in the multicolor color sample and information about sample images included in a single-color color sample for the multicolor color sample in association with each other, the single-color color sample being generated by the image forming apparatus,
a read image receiver that receives a read image, the read image being an image obtained by reading a printed image which is generated by printing, using a single color, an image of a plurality of colors by the image forming apparatus,
a color converter that converts the single color of the read image received by the read image receiver into a plurality of colors on the basis of an association stored in the memory, and
a display that displays an image of the plurality of colors generated through conversion performed by the color converter.

8. An image processing method comprising:
storing, regarding a multicolor color sample including sample images for a plurality of predetermined colors, the colors of the sample images included in the multicolor color sample and information about sample images included in a single-color color sample for the multicolor color sample in association with each other, the single-color color sample being generated by a specific image forming apparatus;
receiving a read image, the read image being an image obtained by reading a printed image which is generated by printing, using a single color, an image of a plurality of colors by the specific image forming apparatus;
converting the single color of the received read image into a plurality of colors on the basis of an association that is stored; and
displaying an image of the plurality of colors generated through conversion.

9. A non-transitory computer readable medium storing a program causing a computer to execute a process for performing image processing, the process comprising:
storing, regarding a multicolor color sample including sample images for a plurality of predetermined colors, the colors of the sample images included in the multicolor color sample and information about sample images included in a single-color color sample for the multicolor color sample in association with each other, the single-color color sample being generated by a specific image forming apparatus;
receiving a read image, the read image being an image obtained by reading a printed image which is generated by printing, using a single color, an image of a plurality of colors by the specific image forming apparatus;
converting the single color of the received read image into a plurality of colors on the basis of an association that is stored; and
displaying an image of the plurality of colors generated through conversion.

10. An image processing apparatus comprising:
a memory that stores a plurality of images, the plurality of images being represented by a single color and represented by shapes or dot patterns different from one another, and that stores predetermined colors each corresponding to one of the plurality of images and predetermined densities each corresponding to one of the plurality of images;
a receiver that receives a read image;
a color converter that performs a conversion process to convert a single color of the read image into a plurality of colors, the read image of the single color including a plurality of images having shapes or dot patterns different from one another, the conversion process including
extracting one of the plurality of images included in the read image,
specifying one of the plurality of images stored in the memory that matches the extracted image,
determining the predetermined color and density stored in the memory in association with the specified image, and
converting the extracted image into an image having the determined color and density,
the color converter repeating the conversion process a plurality of times, thereby converting the single color into the plurality of colors; and
an output unit that outputs the read image of the plurality of colors.

11. A non-transitory computer readable medium storing a program causing a computer to execute a process for performing image processing, the process comprising:
storing a plurality of images in a memory, the plurality of images being represented by a single color and represented by shapes or dot patterns different from one another, and storing predetermined colors each corresponding to one of the plurality of images and predetermined densities each corresponding to one of the plurality of images in the memory;
receiving a read image;
performing a conversion process for color conversion to convert a single color of the read image into a plurality of colors, the read image of the single color including a plurality of images having shapes or dot patterns different from one another, the color conversion including
extracting one of the plurality of images included in the read image,
specifying one of the plurality of images stored in the memory that matches the extracted image,
determining the predetermined color and density stored in the memory in association with the specified image, and
converting the extracted image into an image having the determined color and density,
the conversion process repeating the color conversion a plurality of times, thereby converting the single color into the plurality of colors; and
outputting the read image of the plurality of colors.
